(19) United States
(12) Patent Application Publication
(10) Pub. No.: US 2018/0284672 A1
(43) Pub. Date: Oct. 4, 2018

(54) IMAGE FORMING APPARATUS, IMAGE FORMING SYSTEM, STORAGE MEDIUM AND CONTROL METHOD

(71) Applicant: Sharp Kabushiki Kaisha, Sakai City (JP)

(72) Inventors: Masao SAEDA, Sakai City (JP); Yasuhiro NAKAI, Sakai City (JP)

(21) Appl. No.: 15/936,521

(22) Filed: Mar. 27, 2018

(30) Foreign Application Priority Data
Mar. 29, 2017 (JP) 2017-064207

(51) Int. Cl. G03G 15/00; G06K 15/02; H04N 1/32

(52) U.S. Cl. CPC G03G 15/5016; G06K 15/1809; H04N 2201/3276; G06K 2215/0011; H04N 1/32122

(57) ABSTRACT

An image forming apparatus comprises a first display device and a second display device that is arranged in a position different from the first display device. The first display device functions as a main display device, and the second display device functions as a sub-display device. The main display device is displayed with a main screen including predetermined contents. The main screen includes contents related to the image forming apparatus. The main screen is a setting screen, an operating screen, a preview screen, etc. The sub-display device is displayed with a sub-screen including contents related to the content included in the main screen. Support information, guidance information, an auxiliary input key, etc. are displayed in the sub-screen.

### CROSS REFERENCE OF RELATED APPLICATION

The disclosure of Japanese patent application No. 2017-64207 filed on Mar. 29, 2017 is incorporated by reference.

### BACKGROUND OF THE INVENTION

### Field of the Invention

The present invention relates to an image forming apparatus, an image forming system, a storage medium and a control method, and more specifically, an image forming apparatus, an image forming system, a storage medium and a control method, comprising a plurality of display devices.

### Description of the Related Art

An example of a related art is disclosed in a Japanese patent application laying-open No. 2008-40421 [G03G 21/00] (Literature 1) laid-open on Feb. 21, 2008. A conventional image forming apparatus disclosed in this literature 1 comprises a first operating portion and a second operating portion that is provided in a position lower than the first operating portion. Each of the first operating portion and the second operating portion is provided with an LCD that display devices an operating condition of the image forming apparatus, etc. Moreover, in the conventional image forming apparatus, the second operating portion becomes a usable state by opening a door provided in a main body of the image processing apparatus. However, when the second operating portion becomes a usable state, the first operating portion is disabled and becomes an unusable state. Moreover, the first operating portion becomes a usable state when the door provided in the main body of the image forming apparatus is closed.

In the conventional image forming apparatus, when one operating portion becomes a usable state, the other operating portion becomes an unusable state. That is, in the conventional image forming apparatus, it is impossible to display images on two LCDs simultaneously.

Thus, in the conventional image forming apparatus, since an image can be displayed only on one LCD although the two LCDs are provided, information to be provided to a user is restricted. Therefore, there is room for improvement.

### SUMMARY OF THE INVENTION

It is a primary object of the present invention to provide a novel image forming apparatus, an image forming system, a storage medium and a control method

It is another object of the present invention to provide an image forming apparatus, an image forming system, a storage medium and a control method, capable of providing additional information to a user.

A first invention is an image forming apparatus, comprising: a first display device, a second display device, and a control portion. Each of the first display device and the second display device may be an LCD or an EL (Electro-Luminescence) display device, for example. The second display device is arranged in a position different from the first display device. The control portion is configured to make one of the first display device and the second display device display a main screen including a predetermined content, and make the other of the first display device and the second display device display a sub-screen including a content related to the content included in the main screen. For example, the main screen may be a setting screen, an operating screen, a preview screen, etc.

According to the first invention, a main screen is made to be displayed on one of the first display device and the second display device, and a sub-screen including the content related to the content included in the main screen is made to be displayed on the other of the first display device and the second display device. Therefore, it is possible to provide additional information from the sub-screen to a user.

A second invention is the image forming apparatus according to the first invention, wherein the main screen is an operating screen for operating the image forming apparatus, and the sub-screen includes support information for supporting an operation by the user in the operating screen.

According to the second invention, since the support information for supporting an operation of the user in the operating screen can be provided to the user, the user can operate the image forming apparatus while looking at the support information. Therefore, it is easy to use.

A third invention is the image forming apparatus according to the first invention, wherein the sub-screen includes an auxiliary input key that receives an operation input of the user.

According to the third invention, since an auxiliary input key is displayed in the sub-screen, it is unnecessary to erase the content that is displayed in the main screen in order to receive an operation input, and the auxiliary input key does not overlap with the content displayed in the main screen.

A fourth invention is the image forming apparatus according to the first invention, wherein the sub-screen includes guidance information for guiding the content included in the main screen.

According to the fourth invention, since the guidance information for guiding the content included in the main screen is provided to the user, the user can easily understand the display content of the main screen.

A fifth invention is the image forming apparatus according to the first invention, further comprising an operation situation detecting portion configured to detect an operation situation of the image forming apparatus, wherein the sub-screen includes operation situation information indicating an operation situation of the image forming apparatus in accordance with an operation situation that is detected by the operation situation detecting portion.

According to the fifth invention, since the operation situation information indicative of an operation situation of the image forming apparatus is provided to the user, it is easy for the user to understand the operation situation of the image forming apparatus.

A sixth invention is the image forming apparatus according to the first invention, further comprising an object detecting portion configured to detect existence of a user possessed object, wherein the sub-screen includes notification information for notifying to the user the existence of the user possessed object at a time that a predetermined time period elapses after job completion when it is detected by the object detecting portion that the user possessed object exists.

According to the sixth invention, if it is detected that the user possessed object exists, when a predetermined time period elapses after job completion, the notification information for notifying the existence of the user possessed object to user, and therefore, it is possible to make the user able to recognize the existence of the user possessed object, and prevent the user possessed object from being lost.

A seventh invention is the image forming apparatus according to the first invention, further comprising failure detecting portion configured to detect failure of each of the first display device and the second display device; and a determining portion configured to determine whether each of the first display device and the second display device is displayable when failure is detected by the failure detecting portion, wherein the control portion is configured to make one of the first display device and the second display device display the main screen when it is determined by the determining portion that one of the first display device and the second display device is displayable, and render the first display device and the second display device non-display when it is determined that the first display device and the second display device are undisplayable.

According to the seventh invention, even in a case where failure occurs in the first display device and the second display device, if one of the first display device and the second display device is displayable, it is possible for the user to use the image forming apparatus.

An eighth invention is the image forming apparatus according to the first invention, further comprising a height detecting portion configured to detect a height of a user that uses the image forming apparatus, wherein the control portion is configured to make one of the first display device and the second display device display the main screen according to a detection result of the height detecting portion.

According to the eighth invention, the main screen is made to be displayed on either the first display device or the second display device according to the height of the user with respect to the image forming apparatus. Therefore, since the main screen can be displayed at an appropriate position according to height of an eyes level of the user, it is easy to use.

A ninth invention is a non-transitory computer readable storage medium storing a control program executable by a computer of an image forming apparatus that comprises a first display device and a second display device arranged in a position different from the first display device, wherein the control program causes one or more processors of the computer of the image forming apparatus to function as a control portion that is configured to make one of the first display device and the second display device display a main screen including a predetermined content, and make the other of the first display device and the second display device display a sub-screen including a content related to the content included in the main screen.

A tenth invention is a control method performed in an image forming apparatus that comprises a first display device and a second display device arranged in a position different from the first display device, comprising a step of making one of the first display device and the second display device display a main screen including a predetermined content, and making the other of the first display device and the second display device display a sub-screen including a content related to the content included in the main screen.

An eleventh invention is an image forming system, comprising: an image forming apparatus that comprises a first display device; an information processing apparatus that is communicably connected to the image forming apparatus and comprises a second display device; and a control portion configured to make one of the first display device and the second display device display a main screen including a predetermined content, and make the other of the first display device and the second display device display a sub-screen including a content related to the content included in the main screen.

According to each of the ninth to eleventh inventions, like the first invention, it is possible to provide to the user additional information by the main screen and the sub-screen, respectively.

The above mentioned objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing an appearance configuration of an image forming apparatus that is an embodiment according to the present invention.

FIG. 2 is a block diagram showing electric structure of the image forming apparatus shown in FIG. 1.

FIG. 3 is an illustration view showing an example of a guidance information table.

FIG. 4 is an illustration view showing an example of an auxiliary input table.

FIG. 5 is an illustration view showing an example of a memory map of a RAM shown in FIG. 2.

FIG. 6 is a flow chart showing an example of display processing of the image forming apparatus shown in FIG. 1.

FIG. 7 is a flow chart showing an example of display processing in a second embodiment.

FIG. 8 is a flow chart showing an example of failure processing in a third embodiment.

FIG. 9A is a side view showing a case where a user uses an image forming apparatus in a fourth embodiment, when viewed from a right side.

FIG. 9B is a side view showing a case where another user uses an image forming apparatus in a fourth embodiment, when viewed from a right side.

FIG. 10 is a flow chart showing an example of screen selecting processing in the fourth embodiment.

FIG. 11 is a front view showing an appearance configuration of an image formation system of a modified example.

### DETAILED DESCRIPTION OF NON-LIMITING EXAMPLE EMBODIMENTS

### First Embodiment

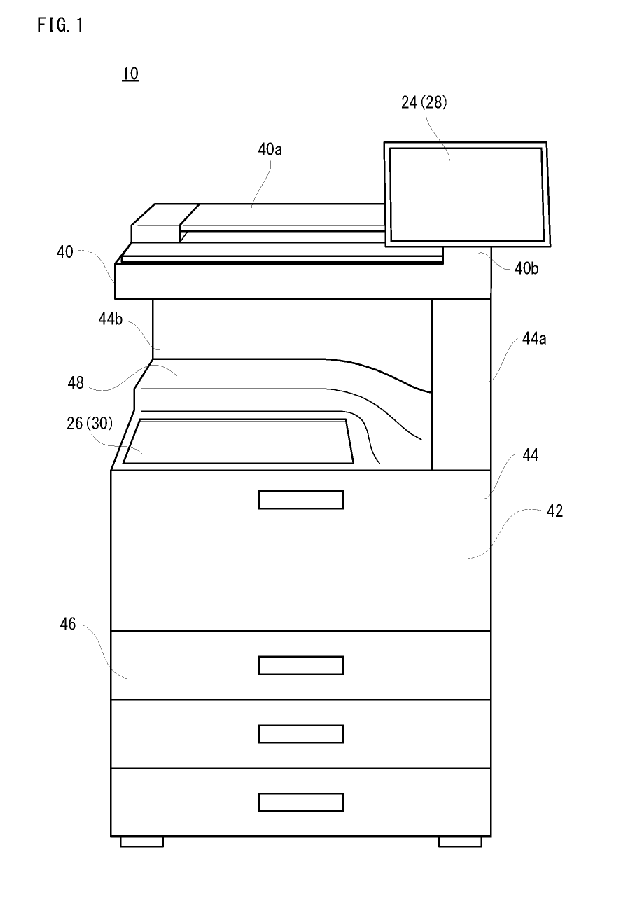

FIG. 1 is a front view showing an appearance configuration of an image forming apparatus 10 that is an embodiment according to the present invention.

With referring to FIG. 1, in this first embodiment, the image forming apparatus 10 is a multifunction machine (MFP: Multifunction Peripheral) having a copying function, a printer function, a scanner function, a facsimile function, etc. In addition, the present invention is applicable not only to an MFP but other image forming apparatus such as a copying machine, a printing device (printer) or a facsimile.

The image forming apparatus 10 comprises an apparatus main body 44 including an image reading portion 40, an image forming portion 42 and a sheet feeder 46.

Moreover, a first display device (first display) 28 with a first touch panel 24 and a second display device (second display) 30 with a second touch panel 26 are provided on the image forming apparatus 10 (apparatus main body 44).

In addition, in this specification, on the assumption that a face of the image forming apparatus 10 opposite to a standing position of the user, that is, a face at a side provided with the first display device 28 and the second display device 30 is a front face (the front), a front-rear direction (depth direction) of the image forming apparatus 10 and its constituent members is defined, and a left-right direction (lateral direction) of the image forming apparatus 10 and its constituent members is defined on the basis of a state that the image forming apparatus 10 is viewed from the user.

The image forming portion 42 is arranged above the sheet feeder 46, and is coupled to the sheet feeder 46. Moreover, the image reading portion 40 is arranged above the image forming portion 42.

Moreover, the apparatus main body 44 comprises a first coupling housing 44a and a second coupling housing 44b for coupling the image reading portion 40 and the image forming portion 42 to each other. The first coupling housing 44a is provided in an upper right portion of the image forming portion 42 (a lower right portion of the image reading portion 40). The second coupling housing 44b is provided in an upper portion on a deep side of the image forming portion 42 (a lower portion on a deep side of the image reading portion 40). The image reading portion 40 is supported with the first coupling housing 44a and the second coupling housing 44b. Thus, an in-body sheet discharge portion 48 that is an in-body space where a recording medium (sheet) having been formed with image is stored is formed below the image reading portion 40.

The image reading portion 40 comprises an original platen that is formed of transparent material, and is incorporated in the apparatus main body 44. A platen cover 40a is attached above the original platen via a hinge etc. to be opened and closed freely.

Moreover, the image reading portion 40 comprises a light source, a plurality of mirrors, a focusing lens, a line sensor, etc. The image reading portion 40 exposes a surface of an original by the light source, and leads a reflected light reflected from the surface of the original to the focusing lens by the plurality of mirrors. Then, the reflected light is focused onto photoreceptor elements of the line sensor by the focusing lens. The line sensor detects brightness and chromaticity of the reflected light that is focused onto the photoreceptor elements, thereby to produce image data based on an image of the surface of the original. As the line sensor, a CCD (Charge Coupled Device), a CIS (Contact Image Sensor), etc. may be used.

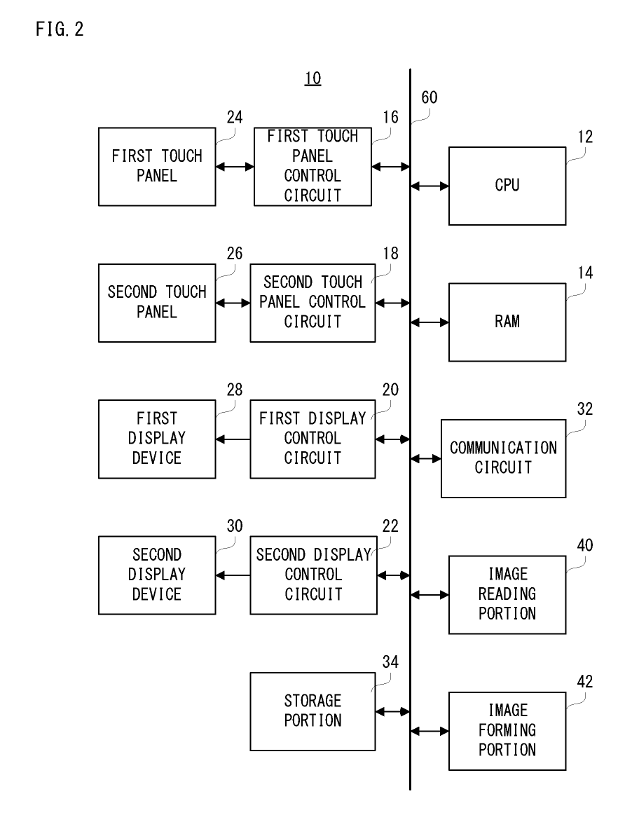

The image forming portion 42 is incorporated in the apparatus main body 44, and provided below the image reading portion 40. The image forming portion 42 comprises an exposure unit, a developer, a process unit, an intermediate transfer belt unit, a transfer roller, a fixing unit, etc. Moreover, the image forming portion 42 forms an image on a sheet that is fed from the sheet feeder 46, and discharges a sheet having been formed with image onto an in-body discharge portion 52. As image data to be used for image forming, image data that is read by the image reading portion 40 (scanned image data), image data that is input from an external computer (input image data) via a communication circuit 32 (see FIG. 2), etc. can be utilized.

Moreover, image data treated in the multifunction machine 10 corresponds to a color image of four (4) colors of black (K), cyan (C), magenta (M) and yellow (Y). Therefore, the developing unit, the photoreceptor drum, the cleaner unit and the charger are respectively provided by four (4) so that four (4) kinds of latent images corresponding to respective colors can be formed, and four (4) image stations are constituted by these components.

The photoreceptor drum is an image bearing member that a photosensitive layer is formed on a surface of a cylindrical substrate having conductivity, and the charger is a member for charging a surface of the photoreceptor drum at a predetermined electric potential (−600V, for example). Furthermore, the exposure unit is constituted as a laser scanning unit (LSU) that comprises a laser emitting portion and reflecting mirrors, etc., and exposes the surface of the photoreceptor drum having been charged, thereby forming an electrostatic latent image according to the image data to be formed on the surface of the photoreceptor drum. The developer visualizes the electrostatic latent image that is formed on the surface of the photoreceptor drum with toners of four (4) colors (YMCK). Moreover, the cleaner unit removes a toner that remains on the surface of the photoreceptor drum after developing and transfer of the toner image, and conveys the removed toner to a waste toner box (not shown).

The intermediate transfer belt unit comprises an intermediate transfer belt, a driving roller, a driven roller, four (4) intermediate transfer rollers, etc., and is arranged above the photoreceptor drum. The intermediate transfer belt is provided so as to be brought into contact to each of the photoreceptor drums, and a multicolor toner image is formed on the intermediate transfer belt by sequentially transferring respective color toner images formed on respective photoreceptor drums onto the intermediate transfer belt in an overlapped manner. Furthermore, the transfer roller is arranged near the driving roller, and when a sheet passes through a nip region between the intermediate transfer belt and the transfer roller, the toner image formed on the intermediate transfer belt is transferred onto the sheet.

The fixing unit comprises a heat roller and a pressure roller, and is arranged above the transfer roller. The heat roller is controlled to be rendered at a predetermined fixing temperature, and when a sheet passes a nip region between the heat roller and the pressure roller, the toner image that is transferred onto the sheet is melted, mixed and pressured, whereby the toner image can be heat-fixed on the sheet.

The first display device 28 and the second display device 30 are arranged in positions different from each other in an up-down direction. Moreover, in the first embodiment, the first display device 28 and the second display device 30 are arranged in positions also different from each other in a left-right direction.

More specifically, the first display device 28 is arranged in an upper portion on a front side of the image reading portion 40. Moreover, the first display device 28 is arranged on the right from the center of the left-right direction of the image forming apparatus 10 (image reading portion 40). However, the first display device 28 is supported by a support member 40b provided in front of the image reading portion 40.

The second display device 30 is arranged on a front left side of the in-body sheet discharge portion 48. That is, the second display device 30 is arranged in an upper portion on the front side of the image forming portion 42.

Thus, in the first embodiment, the first display device 28 is arranged above the second display device 30. Moreover, the first display device 28 is arranged on a right side of the second display device 30.

FIG. 2 is a block diagram showing electric structure of the image forming apparatus 10 shown in FIG. 1. With reference to FIG. 2, the image forming apparatus 10 includes a CPU 12. The CPU 12 is connected, via a bus 60, with a RAM 14, a first touch panel control circuit 16, a second touch panel control circuit 18, a first display control circuit 20, a second display control circuit 22, a communication circuit 32, a storage portion 34, the image reading portion 40 and the image forming portion 42.

Moreover, the first touch panel 24 is connected to the first touch panel control circuit 16, and the second touch panel 26 is connected to the second touch panel control circuit 18. Furthermore, the first display device 28 is connected to the first display control circuit 20, and the second display device 30 is connected to the second display control circuit 22. As the first display device 28 and the second display device 30, an LCD or an EL display can be used, for example.

The CPU 12 is in charge of overall control of the image forming apparatus 10. The RAM 14 is used as a working area and buffer area of the CPU 12.

The first touch panel control circuit 16 applies a voltage required for the first touch panel 24, and detects a touch operation (touch input) in a touch effective area of the first touch panel 24 to output to the CPU 12 touch coordinate data indicating a position of the touch input.

The second touch panel control circuit 18 applies a voltage required for the second touch panel 26, and detects a touch operation (touch input) in a touch effective area of the second touch panel 26 to output to the CPU 12 touch coordinate data indicating a position of the touch input.

However, the first touch panel control circuit 16 outputs to the CPU 12 the touch coordinate data to which a predetermined identifier indicating that the touch coordinate data is of the first touch panel 24 is added. Moreover, the second touch panel control circuit 18 outputs to the CPU 12 the touch coordinate data to which a predetermined identifier indicating that the touch coordinate data is of the second touch panel 26 is added.

As the first touch panel 24 and the second touch panel 26, it is possible to use a touch panel of an arbitrary system such as an electrostatic capacitance system, an electromagnetic induction system, a resistance film system, an infrared system, etc. In this first embodiment, a touch panel of an electrostatic capacitance system is used as the first touch panel 24 and the second touch panel 26. The first touch panel 24 is provided on a display surface of the first display device 28. The second touch panel 26 is provided on a display surface of the second display device 30. However, a touch display that a touch panel and a display device are integrally formed may be used. In such a case, the first touch panel 24 and the first display device 28 are integrally formed, and the second touch panel 26 and the second display device 30 are integrally formed.

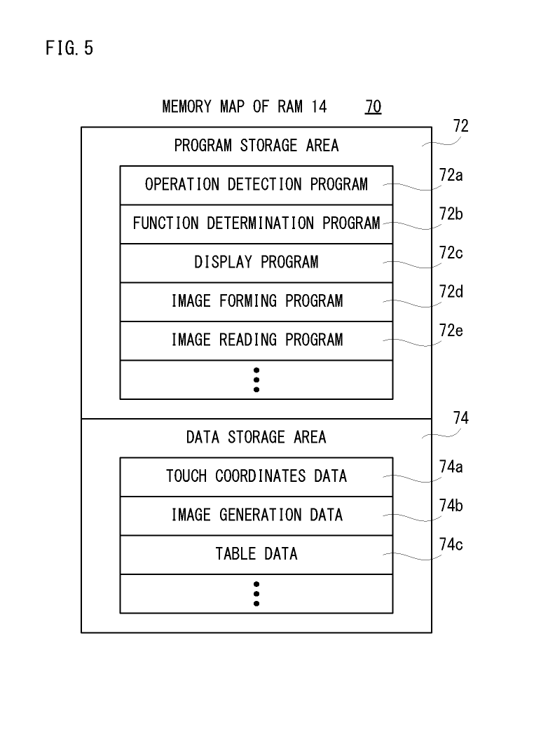

Each of the first display control circuit 20 and the second display control circuit 22 includes a GPU, a VRAM, etc. Under instructions by the CPU 12, the GPU of the first display control circuit 20 generates in the VRAM screen image data for displaying various screens on the first display device 28 with using image generation data 74b (see FIG. 5) stored in the RAM 14, and outputs the generated screen image data to the first display device 28. Under instructions by the CPU 12, the GPU of the second display control circuit 22 generates in the VRAM screen image data for displaying various screens on the second display device 30 with using the image generation data 74b stored in the RAM 14, and outputs the generated screen image data to the second display device 30.

The communication circuit 32 is a communication circuit for connecting with a network such as an internet. This communication circuit 32 is a wire-communication circuit or a wireless-communication circuit, and performs communication with an external computer (external terminal) through the network according to instructions from the CPU 12. However, the communication circuit 32 can also perform communication with an external computer directly by a short-distance wireless communication etc. without using a network.

In addition, the electric structure of the image forming apparatus 10 shown in FIG. 2 is a mere example, and it does not need to be limited to this.

In the conventional image forming apparatus, when one display device out of the first display device 28 and the second display device 30 becomes in a usable (displayable) state, the other display device is rendered to an unusable (undisplayable) state. That is, in the conventional image forming apparatus, it is impossible to display images on the two display devices simultaneously.

Thus, in the conventional image forming apparatus, since an image can be displayed only on one display device although it has two display devices, information to be provided to a user is limited. Accordingly, there is room for improvement.

Then, in this first embodiment, a main screen including a predetermined content is made to be displayed on a display device that is set as a main display device, and a sub-screen including a content related to the content included in the main screen is made to be displayed on a display device that is set as a sub-display device. That is, the screens related to each other are made to be displayed respective ones of a plurality of display devices provided on the image forming apparatus 10.

In this first embodiment, the main display device and the sub-display device are determined in advance. The first display device 28 is set as a main display device, and the second display device 30 is set as a sub-display device.

The main screen includes the content related to the image forming apparatus 10, and is a screen to be displayed when performing various kinds of jobs that the image forming apparatus 10 can perform or performing various kinds of functions that the image forming apparatus 10 can perform. For example, the main screen is a setting screen, an operating screen, a preview screen or the like. Moreover, the display content of the main screen is changed according to the function of the image forming apparatus 10 selected by the user.

In the sub-screen, support information, guidance information, an auxiliary input key, etc. are included. The support information is information for supporting an operation of the user in the main screen. For example, the support information includes information that complements the display content of the main screen or the like. The information that complements the display content of the main screen includes an image that a part of the main screen is enlarged (enlarged image of the main screen) and so on.

The guidance information is information for guiding the display content of the main screen. For example, the guidance information includes information on the explanation of the operating method of the image forming apparatus 10, information on the function of the image forming apparatus 10 and so on.

The auxiliary input key is a software key (function button) for receiving an operation input of the user aside from an operation in the main display device. In addition, the software key refers to, for example, a key reproduced in a software manner on a display surface of the first display device 28 with the first touch panel 24 and the second display device 30 with the second touch panel 26.

For example, the auxiliary input key includes a keyboard, a ten key, a handwriting palette, etc. Although illustration is omitted, the handwriting palette is displayed with function buttons for selecting line type, line color, line width, eraser and cancellation.

The display content of the sub-screen is automatically set according to the display content of the main screen. For example, when the display content of the main screen is a content that requires an operation input of the user, the auxiliary input key is displayed in the sub-screen. On the other hand, when the display content of the main screen is a content that does not require an operation input of the user, the guidance information is displayed in the sub-screen.

However, an initial screen different from the main screen may be displayed on the main display device. This initial screen refers to a screen displayed on the main display device when the image forming apparatus 10 is started or when the image forming apparatus 10 returns from a power saving mode to a normal mode, or the like. For example, the initial screen is a screen for selecting a desired job from various kinds of jobs the image forming apparatus 10 can perform. In the initial screen, the function buttons assigned to various kinds of jobs are displayed, whereby a job can be selected when a corresponding function button is operated by the user. However, in this first embodiment, the job means copying (including scanning of the original), printing, facsimile transmission, etc.

The sub-display device is rendered non-displayed when the initial screen is displayed on the main display device. However, that the sub-display device is rendered non-displayed means that a back light of the display device is turned-off (light-out state), that a single color image (background color image) of the same color as the color around the display device (background color) is displayed on the display device, and so on.

Next, a case where the guidance information is displayed in a sub-screen will be specifically described.

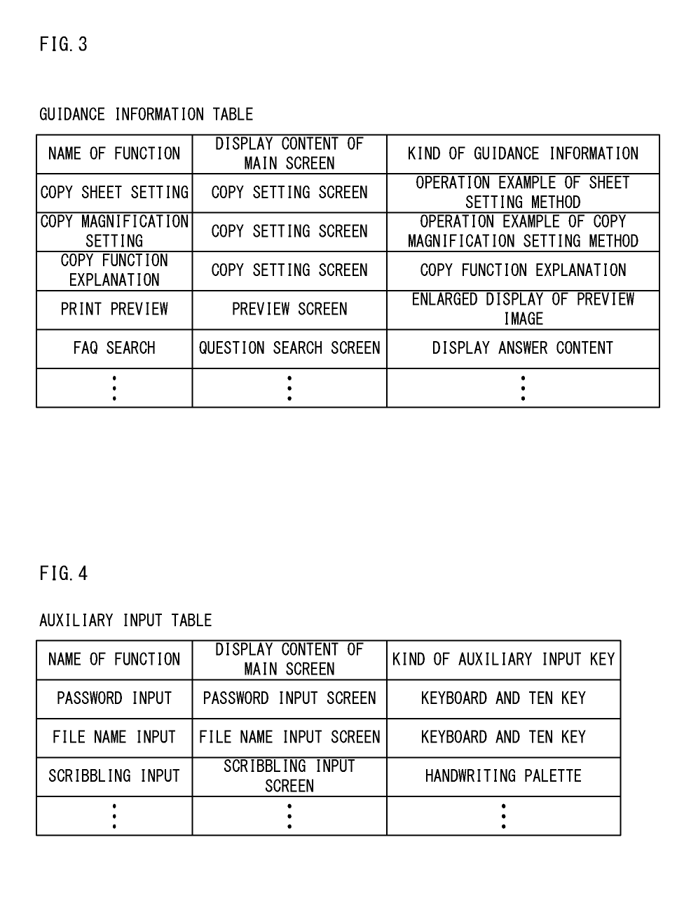

FIG. 3 is an illustration view showing an example of a guidance information table. As shown in FIG. 3, in the guidance information table, a display content of the main display device and guidance information are described corresponding to a name of function of the image forming apparatus 10. Data of this guidance information table is stored in the RAM 14 (see FIG. 5).

When the display content of the main screen is a content that does not require an operation input of the user, the display content of the main screen to be displayed on the main display device and the display content of the sub-screen to be displayed on the sub-display device are determined according to the guidance information table shown in FIG. 3.

In the example of the guidance information table shown in FIG. 3, in a column of the name of function of the image forming apparatus 10, names of events (functions), such as “copy sheet setting”, “copy magnification setting”, “copy function explanation”, “print preview”, “FAQ search”, etc. are described.

However, a content to be described in the column of the name of function of the image forming apparatus 10 is only generated and used by internal processing in the image forming apparatus 10. Therefore, as long as an event is discriminable, the name of event (function) may be numerals, symbols that human beings cannot decipher. Hereinafter, this is the same about the depiction in the guidance information table and an auxiliary input table described later.

Moreover, in a column of the display content of the main screen, letters or characters indicating the display content of the main screen corresponding to the name of the function of the image forming apparatus 10 are described. Furthermore, letters or characters indicating guidance information corresponding to the name of function of the image forming apparatus 10 are described in a column of guidance information.

“Copy sheet setting” means an event that a size, kind, etc. of the sheet on which an image is printed are set when a copy job is performed according to the scanned image data that is read from the original by the image reading portion 40. When performing the “copy sheet setting”, the display content of the main screen is determined to a copy setting screen. Moreover, the display content of the sub-screen is determined to an operation example of a sheet setting method in the copy setting screen.

“Copy magnification setting” means an event that enlargement (reduction) magnification of an image to be printed is set with respect to a size of an image that is read from the original when the copy job is to be performed. When performing the “copy magnification setting”, the display content of the main screen is determined to the copy setting screen. Moreover, the display content of the sub-screen is determined to an operation example of a magnification setting method.

“Copy function explanation” means an event that provides to a user a content of an item that can be changed, content of a performable function, etc. when a copy job is to be performed in the image forming apparatus 10. When performing the “copy function explanation”, the display content of the main screen is determined to the copy setting screen. Moreover, the display content of the sub-screen is determined to explanation of a copy function. In addition, the display content of the sub-screen may be a content of a convenient function or service related to the copy function according to the copy function that the user actually uses.

“Print preview” means an event that display devices an image (print preview image) used for image forming on the display surface of the sub-display device when a copy job or a print job is to be performed. When performing the “print preview”, the display content of the main screen and the display content of the sub-screen is determined to a print preview image. Moreover, the display content of the sub-screen is determined to an image that a part of the preview image is enlarged (magnifier (loupe) function).

“FAQ search” means an event that the user searches an arbitrary question and answer out of information that collects questions and answers with respect to questions that are frequently asked about the image forming apparatus 10 (questions to be predicted in advance). For example, questions frequently asked about the image forming apparatus 10 are an operation method of the image forming apparatus 10, a solution when failure occurs, etc. Moreover, data corresponding to the questions frequently asked about the image forming apparatus 10 may be stored in advance in the storage portion 34 (nonvolatile memory such as an HDD) of the image forming apparatus 10. In this case, if the “FAQ search” is performed, candidates of questions are provided to the user according to an operation of the user, so that the user can select an arbitrary question. When performing the “FAQ search”, the display content of the main screen is determined to a question search screen. Moreover, the display content of the sub-screen is determined to answer content to the question.

Next, description will be made on a case where an auxiliary input key is displayed in the sub-screen.

FIG. 4 is an illustration view showing an example of an auxiliary input table. As shown in FIG. 4, in the auxiliary input table, corresponding to a name of function of the image forming apparatus 10, a display content of the main screen and a kind of auxiliary input key are described. Data of this auxiliary input table is, like the guidance information table, stored in the RAM 14 (see FIG. 5).

When the display content of the main screen is a content that requests an operation input of a user, according to the auxiliary input table shown in FIG. 4, the display content of the main screen to be displayed on the main display device and the display content of the sub-screen to be displayed on the sub-display device are determined.

In the example of the auxiliary input table shown in FIG. 4, “password input”, “file name input”, “scribbling input”, etc. are described in a column of a name of function of the image forming apparatus 10.

Moreover, letters or characters indicative of the display content of the main screen according to the name of function of the image forming apparatus 10 are described in a column of the display content of the main screen. Furthermore, in a column of a kind of an auxiliary input key, letters or characters indicative of a kind of an auxiliary input key according to the title of function of the image forming apparatus 10 are described.

The “password input” means an event requesting of an input of a password in order to perform user authentication when the image forming apparatus 10 needs to identify a user (user authentication). For this event, it may be required, other than a password, to input of further information including a user ID in order to specify a user, etc. When performing the “password input”, the display content of the main screen is determined to a password input screen. Moreover, the display content of the sub-screen is determined to a keyboard and a ten key. In this case, a content that is input by operating the auxiliary input key of the sub-screen is reflected in the main screen (password input screen). Hereinafter, the same is true when the auxiliary input key of the sub-screen is operated.

The “file name input” means an event that requests to input of a file name corresponding to image data when making the image data be stored in the storage portion 34 of the image forming apparatus 10 or a server on a network. When performing the “file name input”, the display content of the main screen is determined to a file name input screen. Moreover, the display content of the sub-screen is determined to a keyboard and a ten key.

The “scribbling input” means an event that adds a handwritten image such as a memorandum to an image (scribbling original source image) corresponding to image data. As an original source image for scribbling, an image (scanned image) corresponding to scanned image data or an image corresponding to image data that is input from an external computer is used. When performing the “scribbling input”, the display content of the main screen is determined to a scribbling input screen. The original source image for scribbling is displayed on a scribbling input screen. Moreover, the display content of the sub-screen is determined to a handwriting palette.

As above, descriptive contents of the guidance information table and operation examples of the image forming apparatus 10 according to the guidance information table, and descriptive contents of the auxiliary input table and operation examples of the image forming apparatus 10 according to the auxiliary input table are described, but the above-described operation examples are mere examples. Information about other events may be described in the guidance information table or the auxiliary input table. Moreover, the display content of the main screen and the display content of the sub-screen that are determined corresponding to an event should just be appropriately set up for each event. Furthermore, the display content of the sub-screen may be a process of an operation input by the user, a progress state of an operation input of the user, or the like.

Moreover, although illustration is omitted, the main screen is displayed with a function button (non-display button) for rendering the sub-screen non-display. When the user operates the non-display button, the sub-screen is rendered non-display. That is, display of the guidance information or display of the auxiliary input key are ended.

Operations of the image forming apparatus 10 as described above are implemented when the CPU 12 executes a control program stored in the RAM 14. Specific processing will be described later using flow charts.

FIG. 5 is an illustration view showing an example of a memory map 70 of the RAM 14 shown in FIG. 2. As shown in FIG. 5, the RAM 14 includes a program storage area 72 and a data storage area 74. As described above, the program storage area 72 of the RAM 14 is stored with the control program of the image forming apparatus 10. The control program includes an operation detection program 72a, a function determination program 72b, a display program 72c, an image forming program 72d and an image reading program 72e.

The operation detection program 72a is a program for detecting an operation to each portion of the image forming apparatus 10. For example, the operation detection program 72a is a program for detecting that each of function buttons included in various kinds of screens, such as the initial screen or the main screen to be displayed on the first display device 28 is operated by acquiring touch coordinate data that is output from the first touch panel 24. Moreover, the operation detection program 72a is also a program for detecting that each of the various kinds of buttons and the auxiliary input key that are included in the sub-screen displayed on the second display device 30 is operated by acquiring touch coordinate data that is output from the second touch panel 26.

The function determination program 72b is a program for determining whether the display content (function selected by the user) of the main screen is a content that requests of an operation input of the user.

The display program 72c is a program that controls the first display control circuit 20 to make the first display device 28 display various kinds of screens, such as the initial screen, the main screen or the like. Moreover, the display program 72c is a program that also controls the second display control circuit 22 to make the second display device 30 display the sub-screen.

The image forming program 72d is a program for controlling the image forming portion 42 to form a multicolor or monochromatic image on a recording medium (sheet) according to image data, such as the scanned image data or the input image data.

The image reading program 72e is a program for controlling the image reading portion 40 to read (scan) the image of the original put on the original platen, thereby outputting an image signal (scanned image data) corresponding to the read image.

In addition, although illustration is omitted, the program storage area 72 is further stored with a program for selecting and executing various kinds of functions that the image forming apparatus 10 is provided, etc.

The data storage area 74 of the RAM 14 is stored with touch coordinate data 74a, image generation data 74b, table data 74c, etc.

The touch coordinate data 74a is touch coordinate data that is detected (acquired) according to the operation detection program 72a. However, as described above, the touch coordinate data includes the touch coordinate data of the first touch panel 24 and the touch coordinate data of the second touch panel 26. Each of the touch coordinate data of the first touch panel 24 and the touch coordinate data of the second touch panel 26 is stored according to a time series.

The image generation data 74b is data for generating display image data corresponding to various kinds of screens to be displayed on the first display device 28 and the second display device 30, such as polygon data, texture data, etc. Moreover, the image generation data 74b includes main screen data corresponding to various kinds of screens such as the main screen to be displayed on the main display device, and sub-screen data corresponding to the sub-screen to be displayed on the sub-display device.

The table data 74c includes data of the guidance information table showing in FIG. 3 and data of the auxiliary input table shown FIG. 4. However, this table data 74c is stored in the storage portion 34 of the image forming apparatus 10, for example. The table data 74c is read from the storage portion 34 of the image forming apparatus 10, and is stored in the RAM 14.

In addition, although illustration is omitted, the data storage area 74 is stored with the scanned image data that is read by the image reading portion 40, the input image data that is input from an external computer, and other data required for executing the control program, and is provided with a register(s) required for executing the control program.

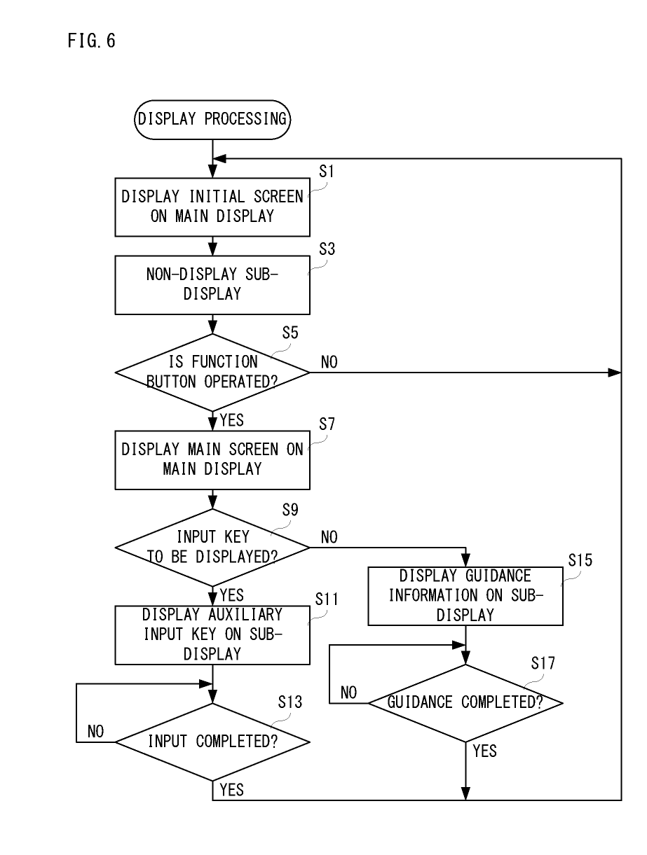

FIG. 6 is a flow chart showing an example of display processing of the image forming apparatus 10 shown in FIG. 1. However, the display processing is started, when the image forming apparatus 10 is initiated, or when the image forming apparatus 10 returns to a normal mode from a power saving mode.

As shown in FIG. 6, when the display processing is started, the CPU 12 makes the main display device display an initial screen in a step S1, and renders the sub-display device non-display in a step S3.

It is determined, in a subsequent step S5, whether any function button is operated in the initial screen. If “NO” is determined in the step S5, that is, if no function button is operated, the process proceeds to the step S1. On the other hand, if “YES” is determined in the step S5, that is, if a function button is operated in the initial screen, the main screen is made to be displayed on the main display device in a step S7. Here, the main screen according to a function assigned to the function button that is operated in the step S5 is displayed on the main display device.

Subsequently, it is determined, in a step S9, whether the function assigned to the function button operated in the step S5 is a function that is to display an input key (requesting an operation input). If “YES” is determined in the step S9, that is, if it is a function that an input key is to be displayed, the CPU 12 makes the sub-display device display the auxiliary input key in a step S11, and it is determined, in a step S13, whether an auxiliary input is to be ended. Here, it is determined whether the operation input is completed. If “NO” is determined in the step S13, that is, if the auxiliary input is not to be ended, the process returns to the same step S13. If “YES” is determined in the step S13, that is, if the auxiliary input is to be ended, the process returns to the step S1.

Moreover, if “NO” is determined in the step S9, that is, if it is a function that does not require to display an input key, the CPU 12 makes the sub-display device display the guidance information in a step S15, and it is determined, in a step S17, whether guide is to be ended. Here, it is determined whether the function assigned to the function button operated in the step S5 is completed. Moreover, it is determined that the guide is to be ended also when the non-display button is operated in the main display device. If “NO” is determined in the step S17, that is, if the guide is not to be ended, the process returns to the same step S17. If “YES” is determined in the step S17, that is, if the guide is to be ended, the process returns to the step S1.

According to this first embodiment, the main screen that includes the content related to the image forming apparatus 10 is made to be displayed on the main display device, and the sub-screen that includes the content related to the main screen concerned is made to be displayed on the sub-display device. Therefore, it is possible to provide the user additional information from each of the main screen and the sub-screen.

Moreover, according to the first embodiment, since the support information that supports an operation by the user in the operating screen can be presented to the user, it is possible for the user to operate the image forming apparatus 10 while looking at the support information, and thus, it is easy to use.

Furthermore, according to the first embodiment, since the auxiliary input key is displayed in the sub-screen, it is unnecessary to erase the content that is being displayed on the main screen in order to accept an operation input, and the auxiliary input key does not overlap with the content displayed in the main screen. Therefore, it is easy to use.

Furthermore, according to the first embodiment, since the guidance information for guiding the display content in the main screen is provided to the user, the user can easily understand the display content of the main screen.

### Second Embodiment

Since an image forming apparatus 10 of the second embodiment is the same as the image forming apparatus 10 of the first embodiment except that operation situation information of the image forming apparatus 10 is displayed on the sub-display device and that notification information about a lost article or forgotten thing is displayed on the main display device or the sub-display device, different contents will be described and duplicate description will be omitted or briefly described.

In the image forming apparatus 10 of the second embodiment, when various kinds of jobs are performed in the image forming apparatus 10, operation situation information indicating an operation situation of the image forming apparatus 10 is displayed on the sub-display device. However, at the time that the user performs various setting or the like the guidance information and the auxiliary input key, etc. are displayed on the sub-display device like the first embodiment, until a job is started.

The operation situation information includes information about a progress situation of a job that is being performed in the image forming apparatus 10, etc. For example, when performing a copy job, the operation situation information includes information each indicating that printing is in progress, printing is temporarily stopped, printing is canceled, failure such as a sheet jam occurs, or the like. Moreover, when performing a print job, the operation situation information includes information each indicating the number of images (the number of pages) included in the input image data, the number of printed sheets, etc.

Moreover, although illustration is omitted, the image forming apparatus 10 of the second embodiment comprises a lost article detection sensor (corresponding to an object detecting portion) for detecting a lost article of the user. In the image forming apparatus 10 of the second embodiment, when a lost article exists, notification information about the lost article is displayed on the main display device or the sub-display device.

The lost article detection sensor detects whether a user possessed object such as an original, printed sheet or the like is left in the image forming apparatus 10 when a predetermined time period elapses after a job is completed. The user possessed objects are an original, printed sheet, recording medium (an SD card, a USB, or a HDD), etc. This lost article detection sensor includes an original detection sensor, a printed sheet detection sensor and a recording medium detection sensor.

For example, as the original detection sensor, a sensor (opening/closing detection sensor) that detects an opened/closed state of the original platen cover 40a, which is constituted by a transmissive optical sensor and an actuator that is moved up and down in response to opening and closing of the original platen cover 40a. The optical sensor includes a light emitting portion that emits a light and a light receiving portion that receives a light emitted from the light emitting portion. The actuator is positioned between the light emitting portion and the light receiving portion when the original platen cover 40a is in a closed state. Therefore, in the optical sensor, the light emitted from the light emitting portion is interrupted by the actuator, and therefore, the light does not enter into the light receiving portion. On the other hand, in the original platen cover 40a is in an opened state, the actuator is moved upward and becomes not positioned between the light emitting portion and the light receiving portion. Therefore, in the optical sensor, the light emitted from the light emitting portion is received by the light receiving portion.

When no light enters into the light receiving portion of the optical sensor, it is determined that the original platen cover 40a is in the closed state. When a light enters into the light receiving portion of the optical sensor, it is determined that the original platen cover 40a is in the opened state.

In the second embodiment, when performing a copy job including scanning of an original, for example, it is determined whether the original platen cover 40a is opened and closed after the copy based on an output of the original detection sensor. When the original platen cover 40a is opened and closed until the predetermined time period elapses after the copy, it is determined that the original is not put on the image reading portion 40 (the original is collected). Moreover, when the original platen cover 40a is not opened and closed until the predetermined time period elapses after the copy, it is determined that the original is put on the image reading portion 40 (the original is not collected).

Moreover, as a printed sheet detection sensor, a mechanical switch using an actuator that functions as the printed sheet detection sensor is provided in the in-body sheet discharge portion 48 that a printed sheet is discharged. The CPU 12 determines whether a sheet having been formed with image exists in the in-body sheet discharge portion 48 based on an on/off of this switch.

The original detection sensor and the printed sheet detection sensor are mere examples, and should not be limited. Detection that the original exists on the original platen and detection that the sheet having been formed with image exists in the in-body sheet discharge portion 48 may be performed by other sensors or other methods.

Moreover, the image forming apparatus 10 may be provided with connection portions (a connector, a memory slot, etc.) by which various kinds of recording media can be attached. In this case, the CPU 12 functions as a recording medium detection sensor that detects whether a recording medium is attached to the connection portion based on whether communication can be performed directly with the recording medium.

In the image forming apparatus 10 of the second embodiment, when it is determined that at least one of the user possessed object remains after the predetermined time period elapses from completion of job, it is determined that the user possessed object concerned is a lost article.

Moreover, in the image forming apparatus 10 of the second embodiment, when it is determined that there is a lost article, notification information for notifying existence of a lost article to the user is displayed on the display near the position of the lost article among the main display device and the sub-display device.

For example, when a lost article is an original, the original is in a state being put on the original platen. In this case, since the first display device (main display device) 28 is closer than the second display device (sub-display) 30 to the original platen, the notification information indicating that the original is not collected is displayed on the first display device 28.

Moreover, when a lost article is a sheet having been formed with image, the sheet concerned is in a state where it is put on the in-body sheet discharge portion 48. In this case, since the second display device (sub-display device) 30 is closer than the first display device (main display device) 20 to the in-body sheet discharge portion 48, the notification information indicating that the sheet having been formed with image is not collected is displayed on the second display device 30.

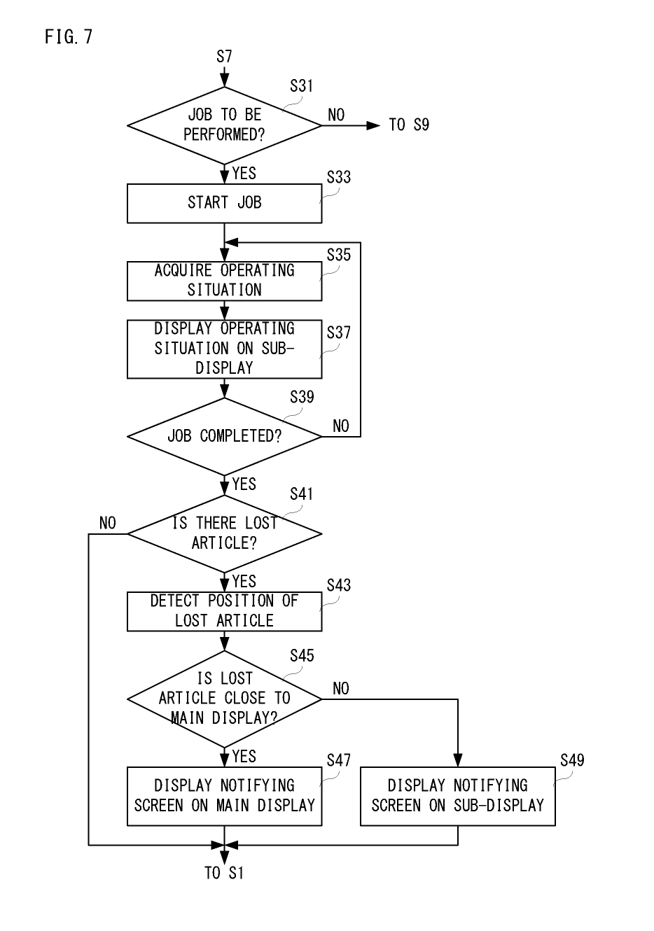

FIG. 7 is a flow chart showing an example of display processing of the second embodiment. About the same processing as the processing described in the display processing (FIG. 6) of the first embodiment, description is omitted or described briefly.

As shown in FIG. 7, when the display processing is started, the CPU 12 makes the main display device display the main screen in the step 7, and it is determined, in a step S31, whether a job is to be performed.

If “NO” is determined in the step S31, that is, if a job is not to be performed, the process proceeds to the step S9. On the other hand, if “YES” is determined in the step S31, that is, if a job is to be performed, a job is started in a step S33.

Subsequently, an operation situation of the image forming apparatus 10 is detected in a step S35, and the operation situation is displayed on the sub-display device in a step S37, and the process proceeds progress to a step S39.

It is determined, in a step S39, whether the job is completed. If “NO” is determined in the step S39, that is, if the job is not completed, the process returns to the step S35. On the other hand, if “YES” is determined in the step S39, that is, if the job is completed, it is determined, in a step S41, whether there is any lost article.

If “NO” is determined in the step S41, that is, if there is no lost article, the process proceeds to the step S1. On the other hand, if “YES” is determined in the step S41, that is, if there is a lost article, a position of the lost article is detected on a step S43, and it is determined, in a step S45, whether the position of the lost article is close to the main display device. Here, it is determined whether the position of the lost article is closer than the sub-display device to the main display device.

If “YES” is determined in the step S45, that is, if the position of the lost article is close to the main display device, a notification screen for notifying the existence of the lost article to the user is displayed on the main display device in a step S47, and then, the process returns to the step S1. On the other hand, if “NO” is determined in the step S45, that is, if the position of the lost article is far from the main display device (close to the sub-display device), a notification screen for notifying the existence of the lost article to the user is displayed on the sub-display device in a step S49, and then, the process returns to the step S1.

In addition, since the processing up to the step S7 and the processing after the step S9 are the same as those of the first embodiment, description will be omitted.

According to this second embodiment, since the operation situation information of the image forming apparatus 10 is displayed on the sub-display device, it is possible to present to the user the information about the operation situation of the image forming apparatus 10, etc., and to improve usability of the image forming apparatus 10.

Moreover, according to the second embodiment, since the notification information about a lost article (a user possessed object) is displayed on the main display device or the sub-display device, when there is a lost article such as an original, a sheet having been formed with image etc. in the image forming apparatus 10, it is possible to prevent loss of the lost article concerned.

In addition, in the second embodiment, when there is a lost article, the notification information is displayed on either one of the main display device or the sub-display device, but the notification information may be made to be displayed on all the display devices provided on the image forming apparatus 10.

### Third Embodiment

Since an image forming apparatus 10 of the third embodiment is the same as the image forming apparatus 10 of the first embodiment except that when failure occurs in the first display device 28 and the second display device 30, the main display device is to be changed according to influence of the failure, different contents will be described and duplicate description will be omitted or briefly described.

There is a case where failure of hardware or software may occur in a plurality of display devices provided on the image forming apparatus 10. In such a case, a display device may become undisplayable due to an influence of the failure. In the image forming apparatus 10 of the third embodiment, each of the first display device 28 (the first display control circuit 20) and the second display device 30 (the second display control circuit 22) and the CPU 12 connected to each other in a manner capable of performing bidirectional communication. When failure occurs in the first display device 28 or the second display device 30, a signal indicative of occurrence of failure is output from the first display control circuit 20 or the second display control circuit 22.

In the image forming apparatus 10 of the third embodiment, when occurring failure that the display set as the main display device becomes undisplayable, a main display device may be changed. For example, when the first display device 28 is set as the main display device, it is assumed that failure occurs in which the first display device 28 becomes undisplayable. In such a case, if the second display device 30 is displayable, the second display device 30 is then set as the main display device. At this time, the first display device 28 is rendered non-display.

Moreover, a case may arise in which failure may occur in all the display devices provided on the image forming apparatus 10, and all the display devices become undisplayable. For example, failure may occur in which both the first display device 28 and the second display device 30 become undisplayable. In such a case, the main display device is not changed. Moreover, both the first display device 28 and the second display device 30 are rendered non-display.

Furthermore, even if failure occurs in the display device that is set as the main display device, the main display device may not be changed if the failure does not make it undisplayable. For example, in a case where the first display device 28 is set as the main display device, even if failure occurs in the first display device 28, the main display device may not be changed if the failure does not make it undisplayable. Moreover, even if failure occurs, all the display devices provided on the image forming apparatus 10 may not be undisplayable. In this case, the main display device is not changed.

In the image forming apparatus 10 of the third embodiment, when failure occurs in the display provided on the image forming apparatus 10, it is notified to the user that failure occurs. For example, if one of the display devices is displayable, a notification screen including a message for notifying of failure is displayed on a display device that is displayable. Moreover, when all the display devices become undisplayable, a sound (melody) or voice etc. notifying failure is output.

Although illustration is omitted, in the third embodiment, the control program stored in the program storage area 72 of the RAM 14 includes a failure detection program and a determination program.

The failure detection program is a program for detecting failure that occurs in the first display device 28 connected to the first display control circuit 20 and the second display device 30 connected to the second display control circuit 22 according to signals that are output from the first display control circuit 20 and the second display control circuit 22.

The determination program is a program for determining whether each of the display devices (for example, the first display device 28 and the second display device 30) provided on the image forming apparatus 10 is displayable when failure is detected according to the failure detection program.

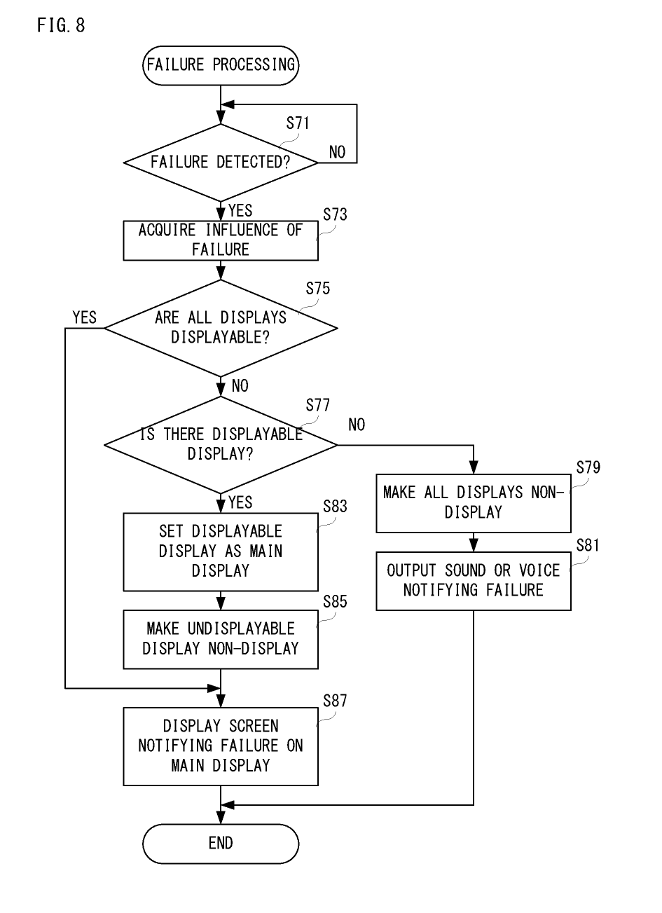

FIG. 8 is a flow chart showing an example of failure processing in the third embodiment. This failure processing is performed in parallel to the above-described display processing.

As shown in FIG. 8, if the failure processing is started, the CPU 12 determines, in a step S71, whether failure in the first display device 28 and the second display device 30 is detected.

If “NO” is determined in the step S71, that is, if no failure is detected, the process returns to the same step S71. On the other hand, if “YES” is determined in the step S71, that is, if failure is detected, an influence of the failure is detected in a step S73, and it is determined, in a step S75, whether all the display devices are displayable.

If “YES” is determined in the step S75, that is, if all the display devices are displayable, the process proceeds to a step S87. If “NO” is determined in the step S75, that is, if there is a display device that is undisplayable, it is determined, in a step S77, whether there is a display device being displayable.

If “NO” is determined in the step S77, that is, if all the display devices are undisplayable, all the display devices are rendered non-display in a step S79, and a sound or voice notifying of the failure is output in a step S81, and then, the failure processing is completed.

On the other hand, if “YES” is determined in the step S77, that is, if there is a display device that is displayable, the display device being displayable is set as the main display device in a step S83, and a display device that is undisplayable is rendered non-display in a step S85, and the process proceeds to a step S87. However, in the step S83, when the display device being displayable is already set as the main display device, the main display device is not changed.

A notification screen including a message for notifying of the failure etc. is displayed on the main display device in the step S87, and the failure processing is completed.

According to this third embodiment, when failure occurs in the first display device 28 and the second display device 30, the main display device is changed according to the influence of the failure. Therefore, if a display device that is displayable exists even when the failure occurs, it is possible for the user to use the image forming apparatus 10.

In addition, such failure includes failure of a touch panel provided in the display device. When the touch panel becomes unusable, it is determined that the display device provided with the touch panel concerned is undisplayble.

Moreover, it is possible to adopt the configuration of the third embodiment into the second embodiment to be combined.

### Fourth Embodiment

Since an image forming apparatus 10 of the fourth embodiment is the same as the image forming apparatus 10 of the first embodiment except that a main display device is set according to a height of the user with respect to the image forming apparatus 10 (apparatus main body 44), different contents will be described and duplicate description will be omitted or briefly described.

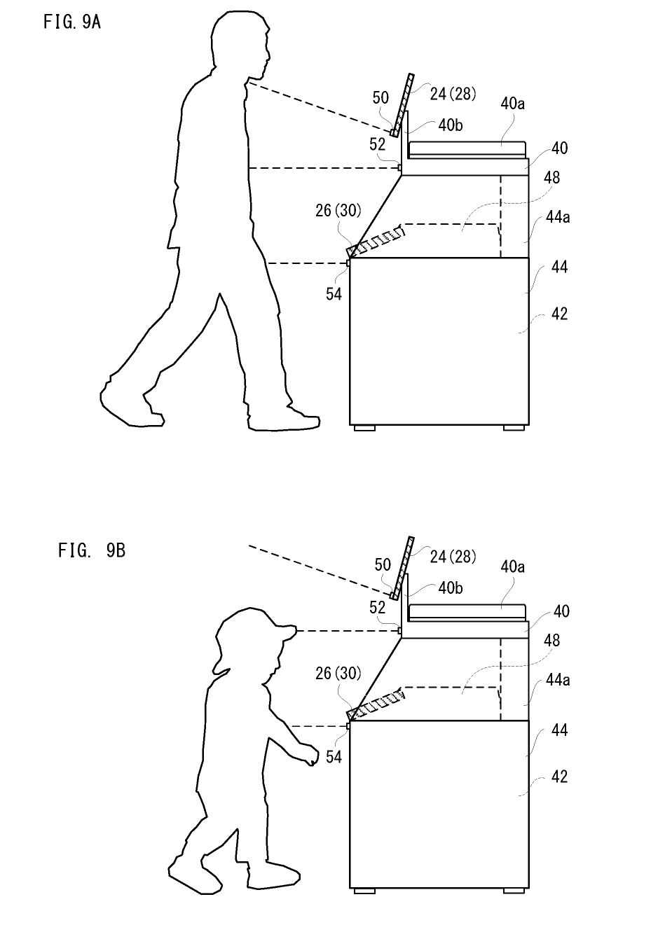

FIG. 9A is a side view showing a state where a user uses the image forming apparatus 10 in the fourth embodiment, when viewed from right side. FIG. 9B is a side view showing a state where another user uses the image forming apparatus 10 in the fourth embodiment, when viewed from right side.

The image forming apparatus 10 of the fourth embodiment further comprises a first person detection sensor 50, a second person detection sensor 52 and a third person detection sensor 54, as shown in FIG. 9A and FIG. 9B. The first person detection sensor 50, the second person detection sensor 52 and the third person detection sensor 54 are sensors (height detection portion) for each detecting the height of the user who uses the image forming apparatus 10 with respect to the image forming apparatus 10 (apparatus main body 44). Here, a height of the user with respect to the image forming apparatus 10 means a height of a head of the user, for example.

The first person detection sensor 50, the second person detection sensor 52 and the third person detection sensor 54 are arranged at different heights, respectively. The first person detection sensor 50 is arranged above the second person detection sensor 52. The third person detection sensor 54 is arranged below the second person detection sensor 52.

For example, the first person detection sensor 50 is arranged at a lower end portion of a front surface of the first display device 28. The second person detection sensor 52 is arranged on a front surface of the image reading portion 40. The third person detection sensor 54 is arranged on a front surface of the image forming portion 42.

Each of the first person detection sensor 50, the second person detection sensor 52 and the third person detection sensor 54 is a distance sensor for detecting a person (user) existing in a predetermined range in front of the image forming apparatus 10, and an infrared sensor, an ultrasonic sensor, a laser distance sensor, etc. can be used, for example. In this fourth embodiment, the CPU 12 detects that a person exists in front of the image forming apparatus 10 when a distance indicated by distance data that is detected by any one of the first person detection sensor 50, the second person detection sensor 52 and the third person detection sensor 54 is equal to or shorter than the predetermined distance.

Moreover, in the fourth embodiment, it is detected whether a person exists in respective heights that the first person detection sensor 50, the second person detection sensor 52, and the third person detection sensor 54 are arranged. However, the height with respect to the image forming apparatus 10 differs for every user. In general, the height of the user with respect to the image forming apparatus 10 is a height corresponding to a body height of the user. Therefore, in case of a tall user, the height of the user with respect to the image forming apparatus 10 becomes high, and in case of a short user, the height of the user with respect to the image forming apparatus 10 becomes low. Thus, the height of the user with respect to the image forming apparatus 10 differs, so that detection results of the first person detection sensor 50, the second person detection sensor 52 and the third person detection sensor 54 are different from each other for each user. Moreover, a fact that the height with respect to the image forming apparatus 10 differs means that a height of an eyes level (height of the eye position or height of the head) differs.

For example, as shown in FIG. 9A, when a user whose height with respect to the image forming apparatus 10 is higher than a predetermined height (tall user) stands in front of the image forming apparatus 10, existence of the user can be detected at all the heights that the first person detection sensor 50, the second person detection sensor 52 and the third person detection sensor 54 are arranged. In this case, it is determined that the height of the user with respect to the image forming apparatus 10 is equal to or more than the predetermined height.

On the other hand, as shown in FIG. 9B, when a user whose height with respect to the image forming apparatus 10 is lower than the predetermined height (short user) stands in front of the image forming apparatus 10, existence of the user can be detected at the heights that the second person detection sensor 52 and the third person detection sensor 54 are arranged. That is, the existence of the user is not detected at the height that the first person detection sensor 50 is arranged. In this case, the CPU 12 determines that the height of the user with respect to the image forming apparatus 10 is less than the predetermined height. Moreover, even if it is a tall user, in a state of the user on a wheelchair, the existence of the user is not detected at the height that the first person detection sensor 50 is arranged. Therefore, it is determined that the height of the user with respect to the image forming apparatus 10 is less than the predetermined height.

In this fourth embodiment, when it is determined that the height of the user with respect to the image forming apparatus 10 is equal to or more than the predetermined height, the first display device 28 arranged on an upper side is set as the main display device. This is because it is thought that the height of the eyes level of the user is also high when the height of the user with respect to the image forming apparatus 10 is high. Moreover, when it is determined that the height of the user with respect to the image forming apparatus 10 is less than the predetermined height, the second display device 30 arranged on a lower side is set as the main display device. It is because it is thought that the height of the eyes level of the user is also low when the height of the user with respect to the image forming apparatus 10 is low.

In addition, although the first person detection sensor 50, the second person detection sensor 52 and the third person detection sensor 54 are used in the fourth embodiment as a sensor for detecting the height of the user with respect to the image forming apparatus 10, should not be limited to this. For example, instead of the first person detection sensor 50, the second person detection sensor 52 and the third person detection sensor 54, a camera may be used. In this case, an image of a person is detected from an image imaged by the camera, and the height of the user with respect to the image forming apparatus 10 is detected according to a position and a size of the image of the person in the imaged image.

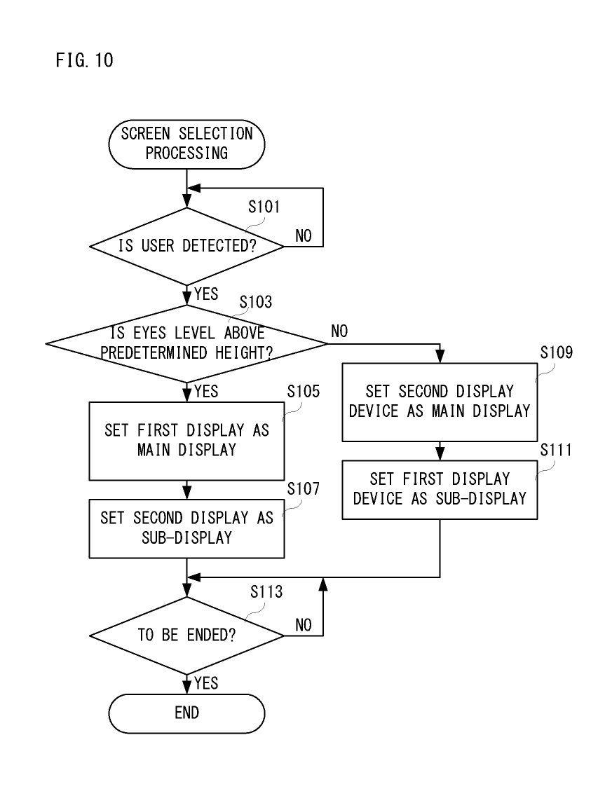

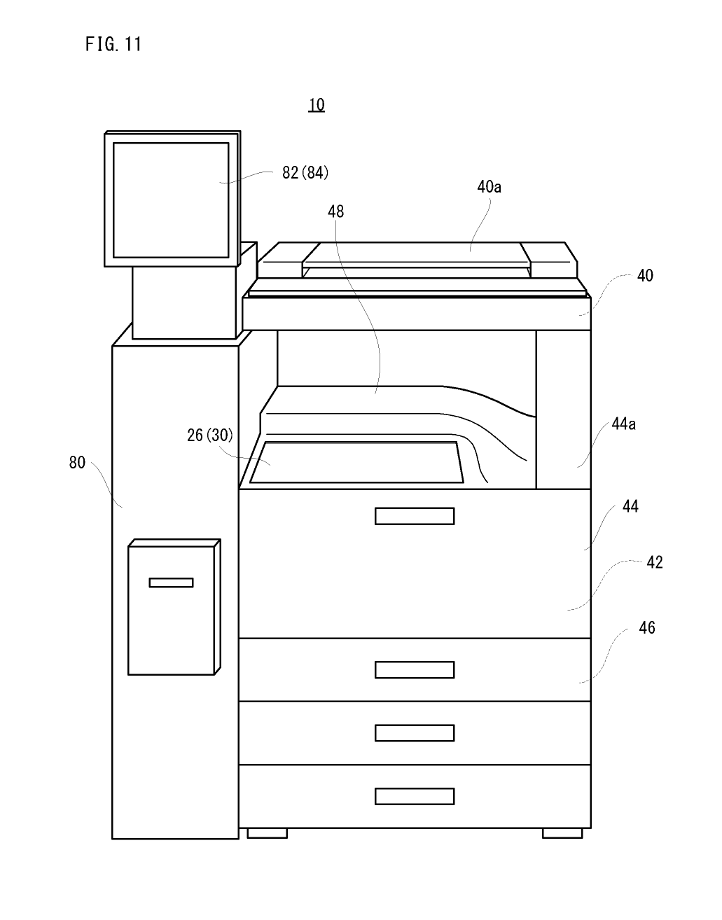

FIG. 10 is a flow chart showing an example of screen selection processing in the fourth embodiment. This screen selection processing is performed in parallel to the display processing described above.

As shown in FIG. 10, if the screen selection processing is started, the CPU 12 determines, in a step S101, whether a user is detected. If “NO” is determined in the step S101, that is, if not detecting a user, the process returns to the same step S101. On the other hand, if “YES” is determined in the step S101, that is, if a user is detected, it is determined, in a step S103, whether the height of the eyes level is equal to or more than the predetermined height.

If “YES” is determined in the step S103, that is, if the height of the eyes level of the user is equal to or more than the predetermined height, the first display device 28 is set as the main display device in a step S105, and the second display device 30 is set as the sub-display device in a step S107, and the process proceeds to a step S113.

If “NO” is determined in the step S103, that is, if the height of the eyes level of the user is less than the predetermined height, the second display device 30 is set as the main display device in a step S109, and the first display device 28 is set as the sub-display device in a step S111, and the process proceeds to the step S113.

In the step S113, it is determined whether the screen selection processing to be ended. If “NO” is determined in the step S113, that is, if the screen selection processing is not to be ended, the process returns to the step S1. On the other hand, if “YES” is determined in the step S113, the screen selection processing is completed.

According to this fourth embodiment, since the main display device is set according to the height of the user with respect to the image forming apparatus 10, it is easy to use.

In addition, it is possible to adopt the configuration of the fourth embodiment into the second embodiment and/or the third embodiment to be combined.

Moreover, although the first display device 28 and the second display device 30 are provided in the image forming apparatus 10 in the above-mentioned embodiments, there is no necessity of being limited to this. For example, as shown in FIG. 11, when the image forming apparatus 10 is arranged at stores, such as a supermarket or a convenience store, there is a case where there is provided with an information processing apparatus 80 that functions as a part of the image forming apparatus 10 or cooperates with the image forming apparatus 10 to configure an image forming system. The information processing apparatus 80 is provided adjacent to the apparatus main body 44, and connected to the CPU 12 in a manner capable of performing communication with it via a cable or wirelessly. Moreover, the information processing apparatus 80 comprises a third display device 84 with a third touch panel 82, and a control portion that includes a billing unit including a coin slot, a coin return port, a change return button, a connection unit (memory slot or the like) capable of attaching various recording media (SD card or USB memory) and a CPU.

In this case, either the first display device 28 or the second display device 30 should just be provided in the apparatus main body 44. For example, when the second display device 30 is provided in the apparatus main body 44, either the second display device 30 or the third display device 84 is set as a main display device, and the other of the second display device 30 and the third display device 84 is set as a sub-display device.

However, when the information processing apparatus 80 functions as a part of the image forming apparatus 10, the CPU 12 of the image forming apparatus 10 performs control for display processing. Moreover, when constituting an image formation system including the image forming apparatus 10 and the information processing apparatus 80, the CPU 12 of the image forming apparatus 10 may perform control about display processing of the image formation system, and the CPU of the information processing apparatus 80 may perform the control about the display processing of the image forming system.

Furthermore, as long as the same result can be obtained in each step of the flow charts shown in the above-described embodiments, an order of processing can be appropriately changed.

As described above, although the present invention has been described with reference to specific embodiments, the present invention is not limited to the above-described embodiments. It should be noted that the above-described specific embodiments are all mere examples, and to be changed appropriately in accordance with specifications of the actual products.

Although the present invention has been described and illustrated in detail, it is clearly understood that the same is by way of illustration and example only and is not to be taken by way of limitation, the spirit and scope of the present invention being limited only by the terms of the appended claims. Furthermore, it is intended that the scope of the present invention covers all modifications within the meaning and range of equivalency of the claims.

What is claimed is:

1. An image forming apparatus, comprising:
a first display device;
a second display device arranged in a position different from the first display device; and
a control portion. configured to make one of the first display device and the second display device display a main screen including a predetermined content, and make the other of the first display device and the second display device display a sub-screen including a content related to the content included in the main screen.

2. The image forming apparatus according to claim 1, wherein the main screen is an operating screen for operating the image forming apparatus, and the sub-screen includes support information for supporting an operation by the user in the operating screen.

3. The image forming apparatus according to claim 1, wherein the sub-screen includes an auxiliary input key that receives an operation input of the user.

4. The image forming apparatus according to claim 1, wherein the sub-screen includes guidance information for guiding the content included in the main screen.

5. The image forming apparatus according to claim 1, further comprising an operation situation detecting portion configured to detect an operation situation of the image forming apparatus, wherein the sub-screen includes operation situation information indicating an operation situation of the image forming apparatus in accordance with an operation situation that is detected by the operation situation detecting portion.

6. The image forming apparatus according to claim 1, further comprising an object detecting portion configured to detect existence of a user possessed object, wherein the sub-screen includes notification information for notifying to the user the existence of the user possessed object at a time that a predetermined time period elapses after job completion when it is detected by the object detecting portion that the user possessed object exists.

7. The image forming apparatus according to claim 1, further comprising failure detecting portion configured to detect failure of each of the first display device and the second display device; and a determining portion configured to determine whether each of the first display device and the second display device is displayable when failure is detected by the failure detecting portion, wherein the control portion is configured to make one of the first display device and the second display device display the main screen when it is determined by the determining portion that one of the first display device and the second display device is displayable, and render the first display device and the second display device non-display when it is determined that the first display device and the second display device are undisplayable.

8. The image forming apparatus according to claim 1, further comprising a height detecting portion configured to detect a height of a user that uses the image forming apparatus, wherein the control portion is configured to make one of the first display device and the second display device display the main screen according to a detection result of the height detecting portion.

9. A non-transitory computer readable storage medium storing a control program executable by a computer of an image forming apparatus that comprises a first display device and a second display device arranged in a position different from the first display device, wherein the control program causes one or more processors of the computer of the image forming apparatus to function as:
a control portion configured to make one of the first display device and the second display device display a main screen including a predetermined content, and make the other of the first display device and the second display device display a sub-screen including a content related to the content included in the main screen.

10. A control method performed in an image forming apparatus that comprises a first display device and a second display device arranged in a position different from the first display device, comprising a step of:
making one of the first display device and the second display device display a main screen including a predetermined content, and making the other of the first display device and the second display device display a sub-screen including a content related to the content included in the main screen.

11. An image forming system, comprising:
an image forming apparatus that comprises a first display device;
an information processing apparatus that is communicably connected to the image forming apparatus and comprises a second display device; and
a control portion configured to make one of the first display device and the second display device display a main screen including a predetermined content, and make the other of the first display device and the second display device display a sub-screen including a content related to the content included in the main screen.
